(19) United States
(12) Patent Application Publication
(10) Pub. No.: US 2008/0027753 A1
(43) Pub. Date: Jan. 31, 2008

(54) Method and System for Optimizing Fund Contributions to a Health Savings Account

(76) Inventor: Daniel Dean, Portland, OR (US)

Correspondence Address: WILMERHALE/BOSTON, 60 STATE STREET, BOSTON, MA, 02109, US

(21) Appl. No.: 11/566,286

(22) Filed: Dec. 4, 2006

Related U.S. Application Data
(60) Provisional application No. 60/820,279, filed on Jul. 25, 2006.

(51) Int. Cl. G06Q 50/00

(52) U.S. Cl. 705/2

(57) ABSTRACT

A computer implemented method for estimating for a user performance information for a health savings account includes estimating a chronological series of health-care expenses to be incurred by the user based on actuarial data for health-care costs and estimating a chronological series of health savings account balance values based on the series of health-care expenses. The method further includes presenting to the user information derived from at least one of the estimated series of health-care expenses or estimated series of health savings account balance values. The method can also include receiving at least one characteristic of the user and modifying the step of estimating the chronological series of health-care expenses such that the actuarial data used to estimate the chronological series of health-care expenses is limited to data associated with individuals that share a similar classification as the user based on the characteristic of the user.

### RELATED APPLICATIONS

This application claims the benefit of U.S. Provisional Application No. 60/820,279, entitled “HSA Savings Calculator”, filed Jul. 25, 2006, the contents of which are incorporated herein by reference.

### BACKGROUND

1. Field of Invention

This invention generally relates to calculators for determining projected balances for health savings accounts.

2. Description of Related Art

A wide variety of health insurance coverage plan types exist in today's health-care industry. While all plan types share the common characteristic of providing some level of coverage for a user's medical expenses, each type of coverage plan has features that are unique to the specific type of plan. Likewise, plan types may differ widely in the costs incurred by the plan user and the amount of flexibility the plan user has in how he or she obtains health care. For example, a health maintenance organization (HMO) provides a type of health insurance coverage plan in which a particular amount of an HMO user's medical expenses are typically paid by the insurance plan only if health care is obtained from health-care providers that have a contract with the HMO.

Another type of health coverage plan is a High Deductible Health Plan (HDHP) with a Health Savings Account (HSA). The HDHP provides traditional insurance coverage for medical expenses, but an HDHP user must first meet a relatively high deductible before the insurance begins to pay or reimburse for certain expenses. The HSA allows a user to put pre-tax money into an account to later reimburse themselves for medical expenses not covered by the insurance, e.g., amounts paid before the deductible has been met or amounts of co-payments required by the HDHP coverage plan before reaching an out-of-pocket maximum value. Any remaining balance in the HSA at the end of the year may be carried forward to reimburse the user for future medical expenses; any interest accrued by the HSA funds is tax-free. Thus, the HSA also has aspects of a traditional savings account.

### BRIEF SUMMARY OF EMBODIMENTS

In one aspect, a computer implemented method for estimating for a user performance information for a health savings account includes estimating a chronological series of health-care expenses to be incurred by the user based on actuarial data for health-care costs, estimating a chronological series of health savings account balance values based on the series of health-care expenses, and presenting to the user information derived from at least one of the estimated series of health-care expenses or estimated series of health savings account balance values.

The method can also include receiving at least one characteristic of the user and modifying the step of estimating the chronological series of health-care expenses such that the actuarial data used to estimate the chronological series of health-care expenses is limited to data associated with individuals that share a similar classification as the user based on the characteristic of the user.

The health-care expenses can be allocated between amounts payable by a health coverage plan, and amounts payable by the user based on a set of health coverage parameters. In such an embodiment, the estimated series of health savings account balance values is further based on the amounts payable by the health coverage plan.

The method can also include estimating a remaining lifespan of the user, calculating a recommended amount of funds to contribute to the health savings account so as to minimize the estimated absolute value of the health savings account balance value occurring at the end of the remaining lifespan of the user, and presenting to the user information derived from the recommended amount of funds. The series of health savings account balance values is further based on the recommended amount of funds to contribute to the health savings account.

In another aspect, a system for estimating for a user performance information for a health savings account includes a computer system, an output device, and program code on a computer-readable medium. The program code, which when executed on the computer system, is capable of performing the functions described above.

In yet another aspect, a computer implemented method of estimating for a user future health-care expenses to be incurred by the user during discrete time periods over a predetermined timeframe includes receiving at least one characteristic of the user for each discrete time period, accessing actuarial data for health-care costs, estimating a series of future health-care expenses to be incurred by the user during the discrete time periods over the predetermined timeframe, and presenting to the user information derived from the estimated series of future health-care expenses. The actuarial data includes cost information associated with health-care costs incurred by individuals, and the data also includes identifying information that characterize the individuals who incurred the health-care costs. Estimating the series of future health-care expenses is based on the cost information contained in the actuarial data associated with only those individuals that share a classification similar to the user. The classification of the user for each discrete time period is based on the characteristic for each discrete time period. The classifications of the individuals are based on the identifying information that characterizes the individuals. The predetermined timeframe can be an estimated remaining lifespan of the user.

The identifying information can include at least ages and/or genders of the individuals when the individuals incurred the health-care costs and at least one of the characteristics of the user received can be an age and/or gender of the user during each discrete time period. The identifying information can also include known health conditions of the individuals when the individuals incurred the health-care costs and at least one of the characteristics of the user received can be a known health condition of the user during each discrete time period.

The method can also include receiving health risk factors possessed by the user, estimating additional health-care expenses to be incurred by the user based on the health risk factors, and presenting to the user information derived from the additional health-care expenses.

In a further aspect, a system for estimating for a user future health-care expenses to be incurred by the user during discrete time periods over a predetermined timeframe includes a computer system, an output device, and program code on a computer-readable medium. The program code, which when executed on the computer system, is capable of performing the functions described above.

These and other features will become readily apparent from the following detailed description wherein embodiments of the invention are shown and described by way of illustration.

### BRIEF DESCRIPTION OF THE DRAWINGS

For a more complete understanding of various embodiments of the present invention, reference is now made to the following descriptions taken in connection with the accompanying drawings in which:

FIG. 1 is a flow diagram of one implementation of an HSA optimizer.

FIG. 2 is an input screen for entering identifying characteristics of a user.

FIG. 3 is an input screen for entering known user chronic health conditions.

FIG. 4 is a flow diagram of one implementation of a user lifetime medical expenses estimation algorithm.

FIG. 5 is a portion of an actuarial data subset categorized according to annual medical expense brackets illustrating a population distribution according to annual medical expense brackets.

FIG. 6 is a mapping of the portion of the actuarial data subset of FIG. 5 to a random number generator range.

FIG. 7 is an input screen for entering health coverage parameters of a user.

FIG. 8 is an illustrative set of results of multiple runs of a total lifetime medical expense scenario simulation.

FIG. 9 is a total lifetime medical expense age distribution.

FIG. 10 is an illustration of the growth of national health expenditures as a share of gross domestic product.

FIG. 11 is a flow diagram of one implementation of an HSA yearly balance projection and HSA contribution optimization algorithm.

FIG. 12 is a presentation screen for presenting annual health-care costs and a projected HSA balance to a user.

FIG. 13 is an illustrative list of health risk factors.

FIG. 14 is an input screen for entering information useful in evaluating a health risk level of a user.

### DETAILED DESCRIPTION

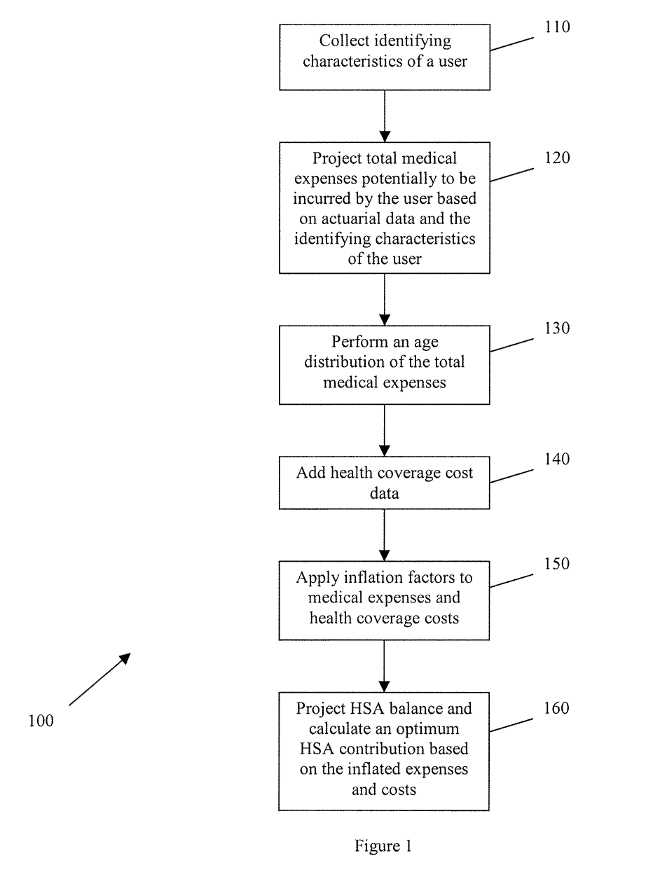

FIG. 1 is a flow diagram of an HSA optimizer 100 that determines an optimal HSA contribution amount for a user. HSA optimizer 100 also generates and displays to the user a projected health-care costs stream for the user occurring across the user's lifetime. HSA optimizer 100 further generates and displays a running HSA balance across the user's lifetime. HSA optimizer 100 can be implemented in a variety of forms, including, for example, a standalone computer application or a client-server web-based application.

HSA optimizer 100 can be one tool in a suite of tools useful for planning for future medical expenses or HSA optimizer 100 can be used alone. When HSA optimizer 100 interacts with other computer-based applications, other “calling applications” may provide information to HSA optimizer 100 upon invoking HSA optimizer 100. Similarly, HSA Optimizer 100 may provide output to calling applications.

HSA optimizer 100 collects identifying characteristics of the user from the user or from another data source that has information about the user (step 110). The identifying characteristics include, for example, age, gender, geographic location of the user, and known health conditions. HSA optimizer 100 uses these characteristics along with actuarial data for health-care costs to estimate yearly medical expenses that the user may potentially incur throughout his or her lifetime and apportions each year's medical expenses into payment categories (step 120). For example, one year's medical expenses may include a portion payable by a health coverage plan, while another portion is identified as out-of-pocket expenses to be paid by the user. HSA optimizer 100 sums the yearly medical expenses and distributes the total over the remaining years of the user's lifetime according to a smoothing algorithm (step 130). Because the cost of obtaining health-care coverage, e.g., health insurance premiums, is not included in the medical expense amounts, HSA optimizer 100 adds an estimated cost of obtaining health-care coverage to each year of the user's life according to a set of health coverage parameters (step 140). Once the medical expenses and health-care coverage costs have been estimated for each remaining year of the user's life, HSA optimizer 100 inflates the medical expenses and coverage costs according to inflation factors or cost growth models (step 150). For example, the expenses and costs are inflated to reflect the current trend of increasing medical expenses and increasing health-care coverage plan premiums. HSA optimizer 100 then projects an annual HSA balance and calculates an optimum HSA contribution amount based on the inflated expenses and costs and desired HSA expenditure parameters supplied by the user (step 160). HSA optimizer 100 can perform the methods and calculations described herein for members of the user's family to determine the family members' impact on medical expenses, health-care coverage costs, and the user's HSA balance. However, for clarity, aspects of HSA optimizer 100 are described by referring only to the user.

As mentioned above, HSA optimizer 100 uses identifying characteristics of the user along with actuarial data for health-care costs to project yearly medical expenses that the user may potentially incur throughout his or her lifetime (step 120). Identifying characteristics can include, for example, age, gender, pre-retirement geographic location, known health conditions, age of retirement, and post-retirement geographic location. In some implementations, HSA optimizer 100 imports identifying characteristics from another source, such as a user's stored profile or health record information that is stored in a computer-accessible manner (e.g., electronic health records stored at a physician site, electronic health records stored at an insurance site, and/or other information storage location). In addition, a calling application can provide identifying characteristics of the user to HSA Optimizer 100.

As previously mentioned, a stored user profile can provide identifying characteristics of the user. One illustrative example of this profile is a master health profile containing information about the user acquired and derived from multiple sources. These sources can include other web-based health related applications that provide data related to the user's current health, past history, and other relevant characteristics. For example, the data may include demographic information, family history, social history, health history, current health status, current and past identified health risks, enrolled health plan information, and other financial factors. The master health profile may also contain information related to the user's web browsing behavior, user self-reported information, and inferred topics of interest to the user.

HSA optimizer 100 can use this information to better estimate the user's medical expenses as well as to better tailor the user's experience with the overall interface of the HSA optimizer 100. HSA optimizer 100 can also provide information to the master health profile based on the results of the various calculations and simulations that the HSA optimizer 100 performs.

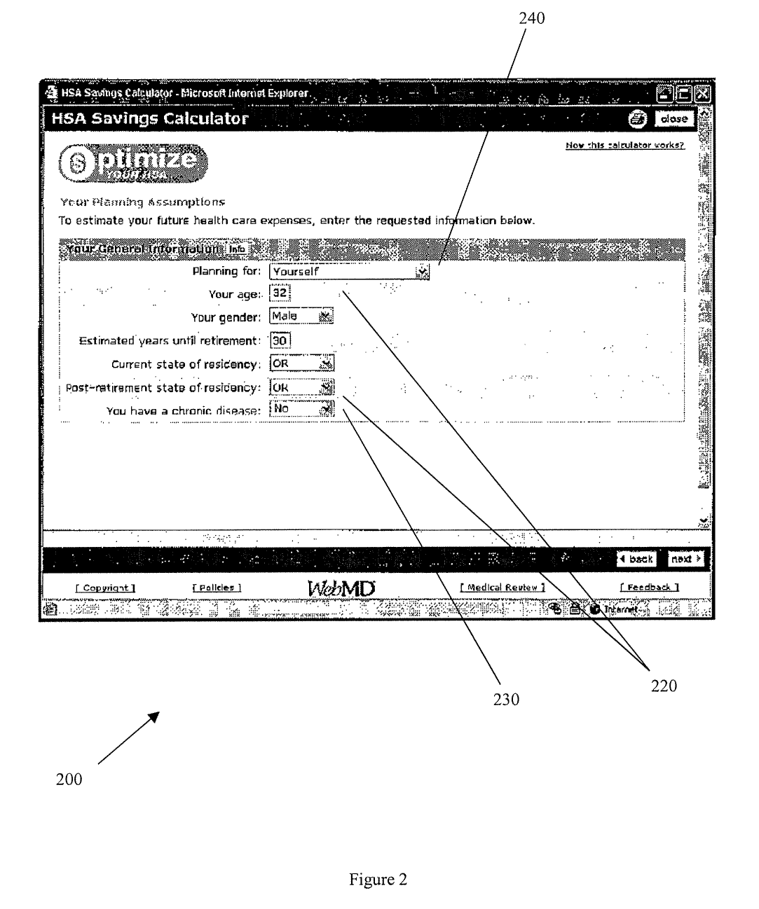

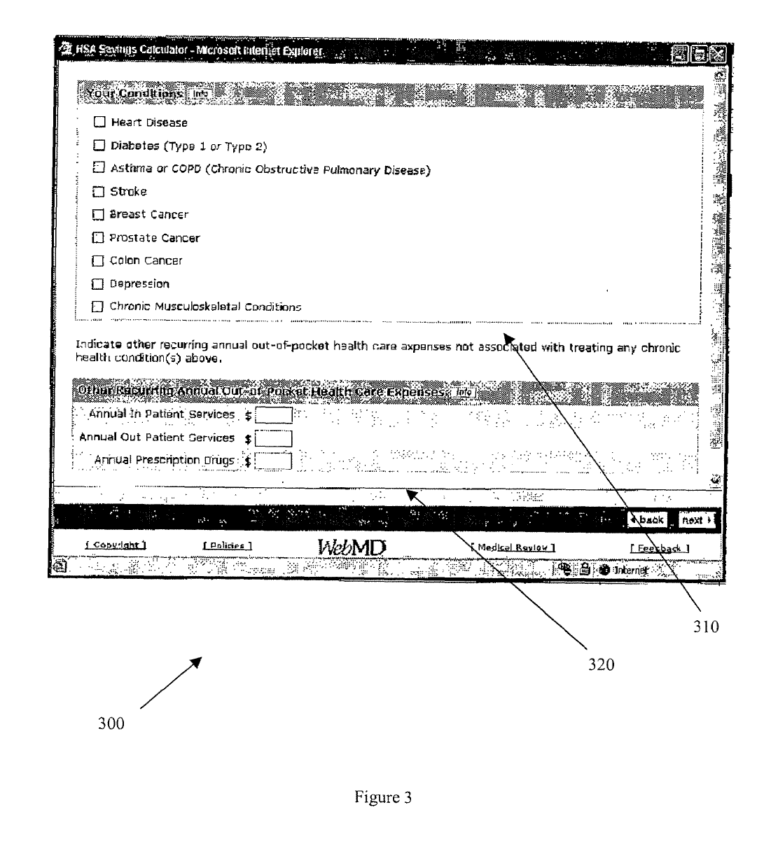

HSA optimizer 100 can also present input screens that solicit the desired identifying characteristics from the user. This information can be used to replace or supplement the information cited in the user's master health profile. FIG. 2 illustrates an input screen 200 for entering the user's identifying characteristics. Input screen 200 contains entry boxes 220 for the user to specify his or her age, gender, estimated years until retirement, current state of residency, and postretirement state of residency. Entry box 230 allows the user to specify whether he or she has a chronic disease. If the user specifies he or she has a chronic disease, the user is presented with a chronic condition screen 300 (FIG. 3) that allows the user to specify the user's chronic conditions in greater detail. Screen 300 contains a conditions section 310 for the user to select from a predetermined set of known chronic conditions, e.g., heart disease, diabetes, stroke, etc. and a known reoccurring costs section 320 for the user to specify known reoccurring costs, e.g., annual inpatient services, annual outpatient services, and annual prescription drug costs. Input screen 200 also includes a planning input box 240 that allows the user to specify whether HSA optimizer 100 should perform calculations for the user only or for members of his or her family as well. If the user elects to perform calculations for his or her family members, screens similar to 200 and 300 are also used to solicit identifying characteristics for the user's family members.

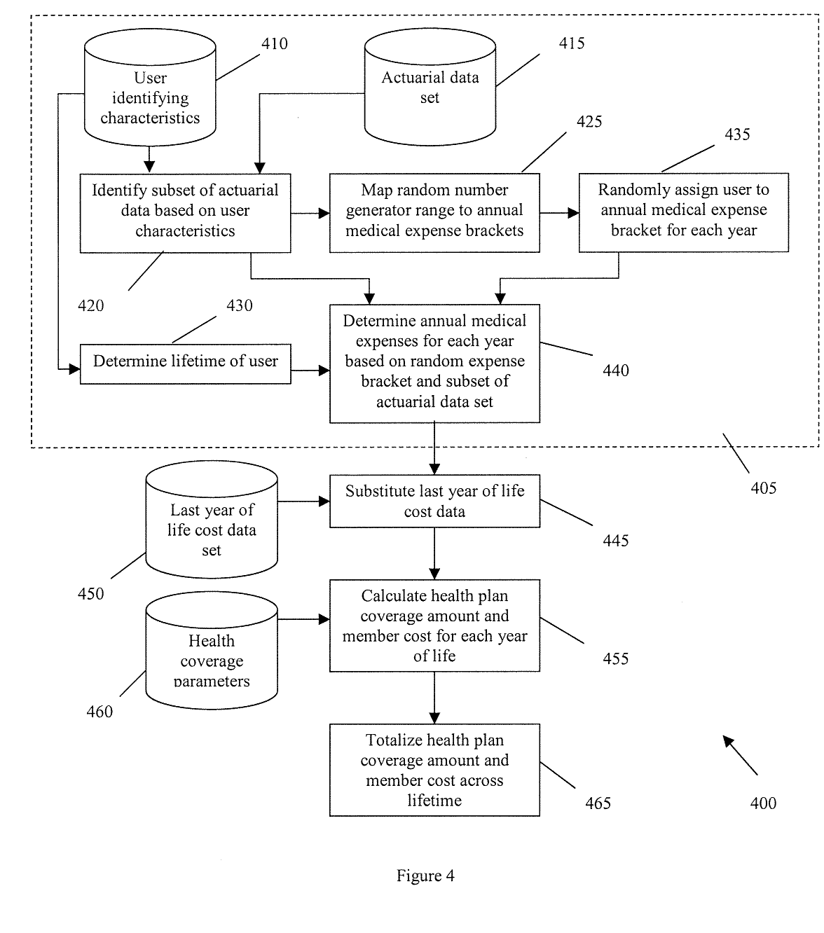

HSA optimizer 100 implements an algorithm for generating the total medical expenses that the user may potentially incur throughout his or her lifetime (step 120 of FIG. 1). FIG. 4 is a flow diagram of one illustrative algorithm and data sources 400 for generating these expenses. In general, a set of calculations identified by box 405 (herein “calculations 405”) is performed for each year of the user's remaining life. Calculations 405 first determine the likely length of the user's life and then estimate an annual medical expense amount likely to be incurred by the user during each year of his or her remaining life. Algorithm 400 allocates the annual medical expenses determined for each year into an amount payable by a health coverage plan (covered amount) and an amount payable by the user (uncovered amount). Algorithm 400 separately sums the covered and uncovered amounts to generate an estimated lifetime total covered medical expense amount and an estimated lifetime total uncovered medical expense amount.

The user's future annual medical expenses are simulated by assuming the user will incur annual medical expenses similar to historical annual medical expenses incurred by individuals who share the identifying characteristics of the user. These historical annual medical expenses are provided in an actuarial dataset 415. Actuarial data set 415 contains health-care cost data, including medical expenses incurred by a large population of sample individuals that used the health-care system categorized according to identifying characteristics of the sample individuals. For example, actuarial data set 415 contains total medical expenses incurred by each sample individual categorized according to his or her age, gender, geographic region, and known health conditions. The actuarial data set is created from commercially available medical and pharmaceutical health-care insurance claims, such as those available from PHARMetrics, Inc., of Watertown, Mass. For each year of the user's life that is simulated, algorithm 400 designates a subset of actuarial data set 415 to use to estimate the user's annual medical expenses by using the actuarial data associated with the sample individuals having identifying characteristics matching user identifying characteristics 410 (step 420). Because user identifying characteristics 410 change with each year simulated, e.g., the user's age increases and the user's geographic location may change upon retirement, the subset of actuarial data set 415 used also changes with each simulation year.

In any large sample population of individuals with similar characteristics, some members of the subset sample population will have higher annual medical expenses than other members of the subset sample population due to variations in the health care required by members of the population. Thus, the collection of annual medical expenses incurred by members of the subset sample population represent a spectrum along which the user's annual medical expenses could potentially fall in a given year. Thus, one difficulty of accurately estimating where along this spectrum any particular one of the user's future annual medical expense amounts should fall comes from the fact that the user may experience unpredictable events and acute medical expenses in any future year.

Algorithm 400 uses a stochastic simulation approach to capture this uncertainty. Algorithm 400 divides the historical annual medical expense spectrum of the actuarial data subset into discrete annual expense brackets and randomly assigns an expense bracket to the particular year of the user's life. Thus, the simulation of the user's lifetime medical expenses created by algorithm 400 will be comprised of some years with medical expenses on the low end of the spectrum, some years with medical expenses in the middle of the spectrum, and some years with medical expenses on the high end of the spectrum. However, theories of probability dictate that the user is more likely to fall within certain annual medical expense brackets than others. The probability of the user falling into a particular annual medical expense bracket is governed by the distribution of the subset sample population among the annual medical expense brackets. In other words, the user will be more likely to fall into an annual medical expense bracket having a relatively larger population than an annual medical expense bracket having a relatively smaller population. Algorithm 400 simulates the likelihood of the user falling into a particular annual medical expense bracket by allocating a portion of a random number generator range to the particular annual medical expense bracket according to the relative population of the bracket.

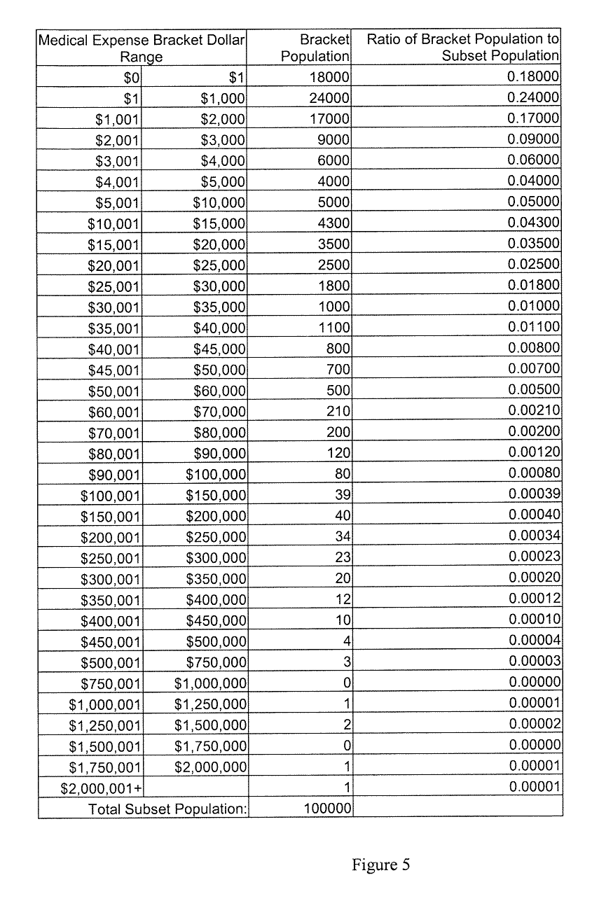

Referring to FIG. 5, an illustrative portion of a subset of actuarial data set 415 has a total population of 100,000 sample individuals with characteristics matching user identifying characteristics 410. In the subset, 18,000 sample individuals fall within a $0-$1 annual medical expense bracket, 24,000 sample individuals fall within a $1-$1,000 annual medical expense bracket, 17,000 sample individuals fall within a $1,001-$2,000 annual medical expense bracket, and so on. This distribution of sample individuals according to medical expense bracket ranges is used to represent the probability of the user falling into a particular annual medical expense bracket in a particular year during the simulation. As explained above, the user will be more likely to fall into an annual medical expense bracket having a relatively larger population than an annual medical expense bracket having a relatively smaller population.

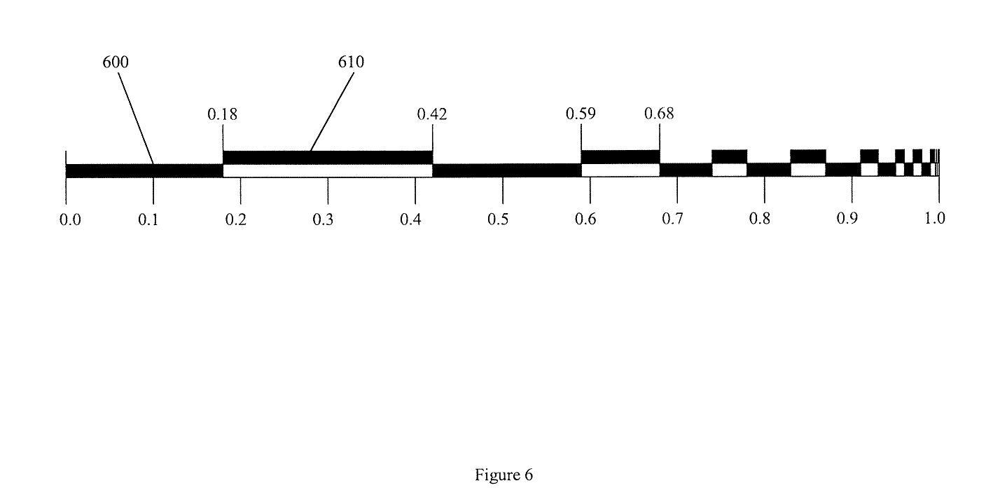

In order to capture the likelihood that the user will fall into a more heavily populated annual medical expense bracket, algorithm 400 maps a random number generator range to the medical expense brackets designated in the subset of actuarial data set 415 (step 425). The “width” of the medical expense brackets can be a predetermined fixed amount (e.g., all expense brackets are $1,000 wide), or the brackets can vary in width according to some variable (e.g., the would-be population of the bracket or the magnitude of the midpoint of the bracket). FIG. 6 illustrates an illustrative mapping of a random number generator range to the subset of FIG. 5. In this example, the random number generator range is 0-1, shown along the horizontal axis of FIG. 6. As explained above, it is more likely that a given user will fall within an annual medical expense bracket having a relatively larger population of sample individuals. Thus, portions of the random number generator range are allocated to the annual medical expense brackets in proportion to the relative populations of the annual medical expense brackets. These portions are converted into corresponding starting and ending values along the random number generator range by scaling the portions to the random number generator range, e.g., by multiplying the portions allocated to the medical expense brackets by the magnitude of the random number generator range and taking the previous bracket's ending value as the next bracket's starting value.

For example, a portion 600 of the random number generator range allocated to the $0-$1 annual medical expense bracket is proportional to the ratio of its population to the total sample population, i.e., (18,000/100,000)=0.18. This portion, 0.18, is multiplied by the magnitude of the random number generator range, 1.0, to calculate the scaled portion of the random number generator range, 0.18. Because this is the first bracket in the subset, its starting value is 0. Its ending value is the scaled portion, 0.18, plus the starting value of 0. Therefore, the portion of the random number generator range assigned to the $0-$1 annual medical expense bracket is any random number greater than or equal to 0 and less than 0.18. A portion 610 of the random number generator range allocated to the $1-$1,000 annual medical expense bracket is determined in the same way using its population of 24,000. The scaled portion of the random number generator range assigned to the $1-$1,000 annual medical expense bracket is 0.24. The starting value of this bracket is the ending value of the previous bracket, 0.18. The ending value of this bracket is 0.42, which is the scaled portion, 0.24, plus the starting value of 0.18. Thus, the portion of the random number generator range assigned to the $1-$1,000 annual medical expense bracket is any random number greater than or equal to 0.18 and less than 0.42. Likewise, algorithm 400 maps other portions of the random number generator range to the remaining annual medical expense brackets. Although algorithm 400 maps the random number generator range to the medical expense brackets population ratios on a linear basis, other mapping relationships may be used.

As mentioned above, calculations 405 are performed for each year of the user's estimated remaining life. Algorithm 400 estimates the user's remaining lifespan using lifespan actuarial tables based on user identifying characteristics 410 (step 430). Because calculations 405 are performed for each year of the user's remaining life, the length of the user's lifetime dictates the number of times calculations 405 will be performed during the simulation. During each year of the simulation run, the user's identifying characteristics are modified to reflect the fact that the user's identifying characteristics change during each year of life simulated. Because the user's age is different for each simulated year of his or her remaining life, a new subset is created from the actuarial data set each time calculations 405 are performed. For example, while one portion of the actuarial data set will be used to determine the annual medical expenses when the user is 53 years old, a different portion of the actuarial data set will be used to determine the annual medical expenses when the user is 54 years old. Thus, a new mapping is created for this new subset for each simulated year of the user's remaining life.

Using the techniques described above increases the accuracy of the medical expense predictions while retaining the uncertainty involved in predicting a future event. Using the actuarial data of individuals with characteristics matching the user's identifying characteristics to generate the spectrum of possible medical expenses increases the accuracy of the predictions because individuals with certain similar characteristics are likely to experience similar medical expenses. Meanwhile, randomly assigning the user to one of a collection of annual medical expense brackets within the matched subset of actuarial data captures the fact that the user may experience unpredictable events and/or incur acute costs not typical of similar individuals. Thus, the unpredictable nature of estimating future medical expenses is retained, but the unpredictability is constrained within a range that is informed by the user's characteristics and known conditions. In addition, because the average annual medical expense value of an actuarial data subset not divided into brackets can be skewed by high annual medical expense outliers, dividing the subset into annual medical expense brackets according to the techniques described above allows HSA optimizer 100 to select an average annual medical expense most likely to be incurred by the user.

For example, although it is possible that a healthy user may incur no medical expenses in a given year, it is very unlikely that a user with a known chronic medical condition would experience a year without medical expenses. The unlikelihood of this fact is reflected by a low (or zero) population of the $0-$1 annual medical expense bracket in the actuarial data associated with individuals that have a similar known chronic medical condition. The $0-$1 annual medical expense bracket is accordingly mapped to a very small portion (or no portion) of the random number generator range. Conversely, an annual medical expense bracket with the greatest proportion of the subset population will be mapped to the greatest proportion of the random number generator range. Thus, by creating a spectrum of possible medical expense brackets based on the actuarial data of individuals with a similar known chronic medical condition, algorithm 400 captures the fact that the user will likely incur an amount of medical expenses incurred by similar individuals.

Referring again to FIG. 4, once algorithm 400 has assigned the user to a random annual medical expense bracket based on a unique random number and a unique annual medical expense bracket mapping for each year of the simulation (step 435), algorithm 400 then determines the annual medical expense amounts for each simulated year (step 440). Algorithm 400 uses the average medical expense of the population of sample individuals in the assigned annual medical expense bracket as the annual medical expense amount to be incurred by the user for the particular year of the simulation.

Medical expenses incurred by a person during his or her last year of life tend to be higher than medical expenses incurred by others of the same age that live longer. Thus, algorithm 400 uses a value taken from a last year of life cost data set 450 in place of the annual medical expense amount determined by calculations 405 (step 445). The last year of life cost data set 450 is generated from the actuarial data set by taking the average annual medical expenses incurred during the last year of life of the sample individuals sorted according to the sample individuals identifying characteristics.

After the series of annual medical expenses has been generated for the user, the algorithm 400 calculates what portion of each annual amount is payable by a health coverage plan (covered amount) and what portion is payable by the user (uncovered amount) according to a set of health coverage parameters 460 (step 455). These parameters include a deductible amount, co-insurance percentages, and an out-of-pocket maximum value. For example, a typical HDHP requires the user to meet an annual deductible before the HDHP pays benefits. Once the user has met the annual deductible, the user pays a percentage of the medical expenses he or she incurs (the co-insurance amount) up to a maximum amount for the year (the annual out-of-pocket maximum). Health coverage parameters 460 are provided by the user as described below, but they can also be a predetermined set of parameters, provided by the user's profile, or provided by a calling application.

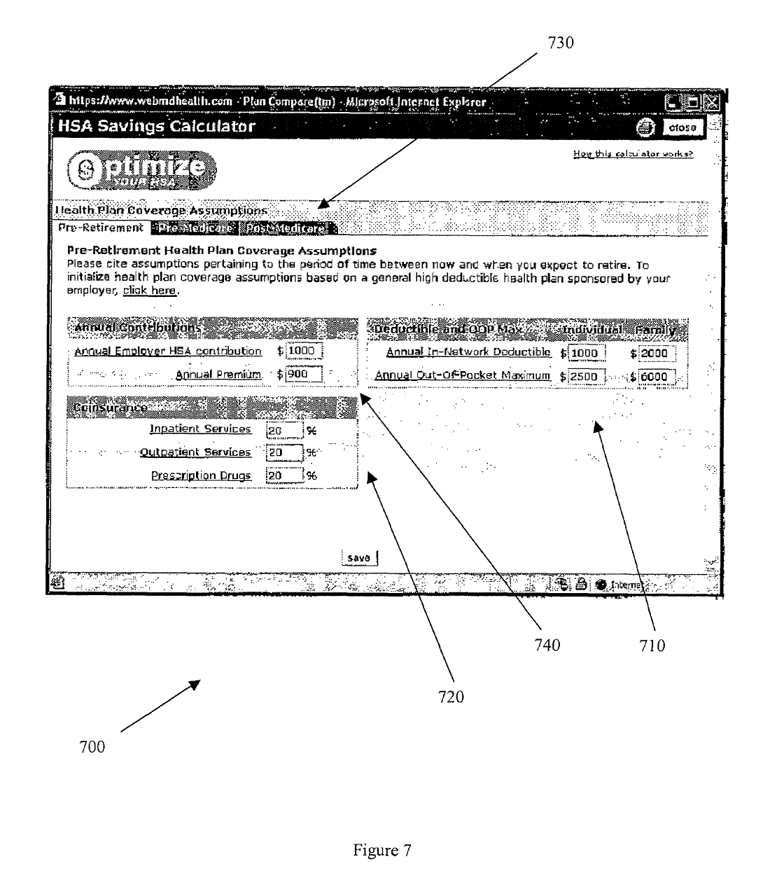

FIG. 7 provides an example of a health coverage parameter input screen 700 that solicits health coverage parameters from the user. Parameter input screen 700 has a deductible and out-of-pocket limits section 710 and a coinsurance parameters section 720. Parameter input screen 700 can be divided into sub-screens 730 that allow the user to configure health coverage parameters for the periods covering pre-retirement, post-retirement/pre-Medicare, and post-Medicare. Thus, the annual medical expenses are divided into covered and uncovered portions according to different sets of parameters depending upon the age of the user, which in turn is governed by the particular year being simulated.

Algorithm 400 then sums the covered amounts and uncovered amounts for each year of the user's life to arrive at a lifetime total covered amount of medical expenses and a lifetime total uncovered amount of medical expenses (step 465). A single lifetime simulation run represents only one possible lifetime total medical expense scenario. Thus, a single run may over or under estimate a user's total medical expenses. In order to generate a more accurate estimate of the total amount, HSA optimizer 100 runs algorithm 400 many times (e.g., 250 times) and uses the collection of many possible total medical expense scenarios to determine a reasonable estimate as described below.

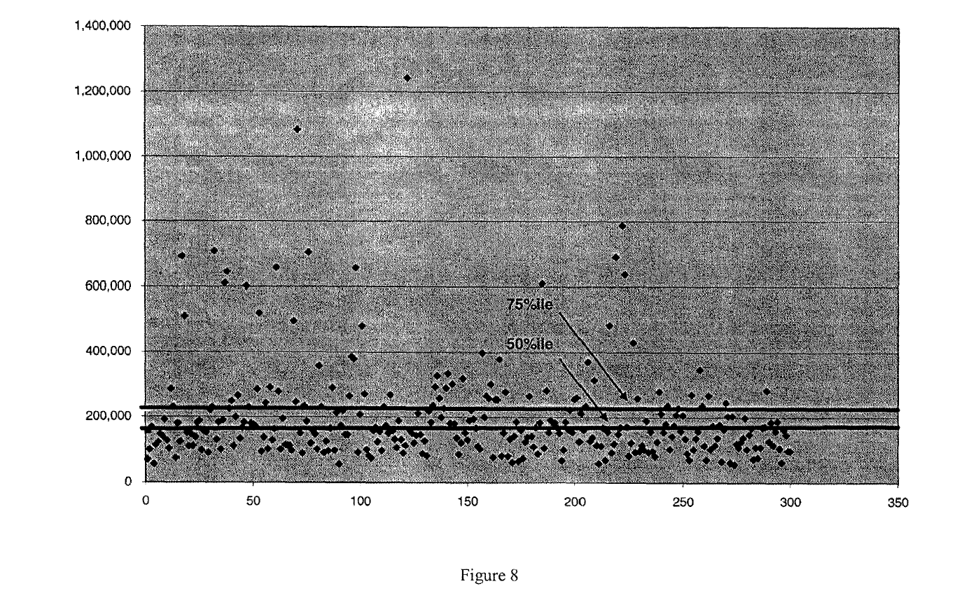

FIG. 8 is an example set of total lifetime medical expenses scenarios. The Y axis of FIG. 8 is in dollars. The data points of FIG. 8 are total lifetime covered medical expenses determined according to algorithm 400. Algorithm 400 creates a similar set of data points for uncovered amounts. In this example, 300 individual lifetime simulation runs of algorithm 400 were performed. Thus, 300 individual total lifetime covered medical expense data points were generated. Once the individual data points have been generated, a total lifetime covered medical expense value is derived from the data points using a percentile value. This derived value is used as the total lifetime covered medical expenses of the user. For example, a 50th percentile value represents one possible estimate of the projected total lifetime covered medical expenses of the user. A 75th percentile value could be used in place of the 50th percentile value for a more conservative estimate of the total lifetime covered medical expense value. The percentile used can be predetermined, can be provided by a calling application, or can be a user-configurable option.

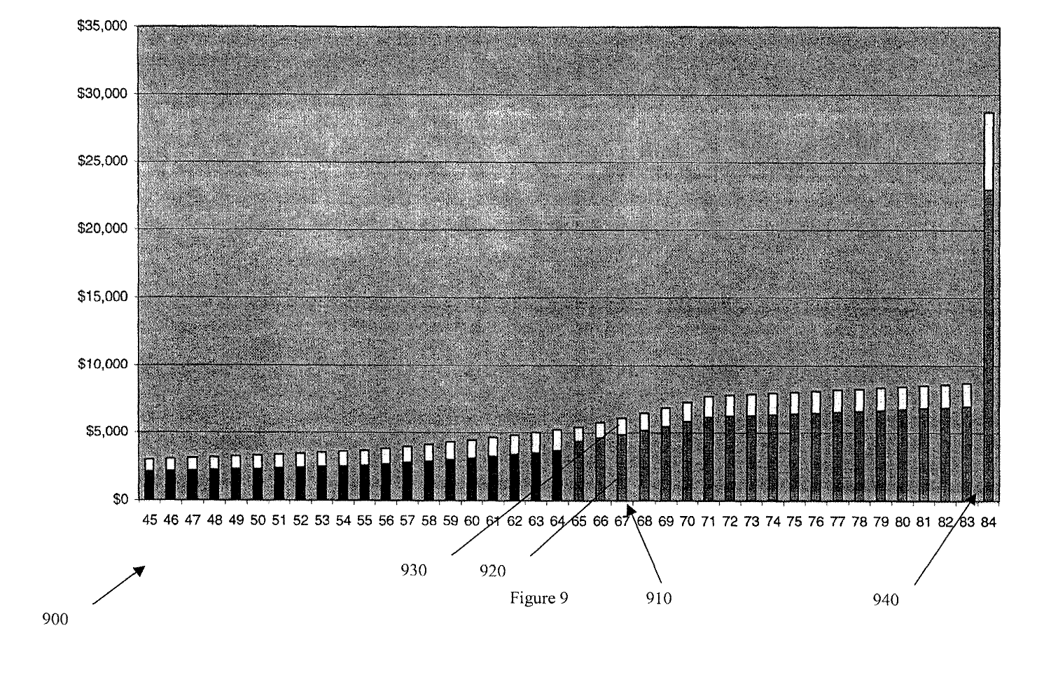

This derived total lifetime value is distributed over the years of the user's remaining life according to an age/medical expense curve that assigns a percentage of the total lifetime covered medical expenses to a particular year given the user's age (step 130 of FIG. 1). The age/medical expense curve can be determined by analyzing known historical health-care cost data. Age/medical expense curves and methods of generating them are known in the art. FIG. 9 is an example age distribution 900 of a derived total lifetime medical expense value. An individual annual medical expense value 910 shows both a covered amount of expenses 920 and an uncovered amount of expenses 930 for the particular year. The age/medical expense curve used to distribute the total lifetime medical expenses over the remaining years of the user's life can be adjusted to reflect the last year of life amount of medical expenses taken from the last year of life cost data set (shown by last year of life expenses 940).

The steps and techniques described above are used to generate a lifetime estimate of the user's medical expenses, e.g., the cost of visiting the doctor's office, hospital bills, and prescription medication costs. However, HSA optimizer 100 also takes into account the costs associated with obtaining health-care coverage, e.g., HDHP insurance premiums. Health-care coverage cost data is added to the age distributed covered and uncovered medical expenses based on health-care coverage cost parameters (step 140 of FIG. 1). The health-care coverage cost parameters can vary according to the age of the user. For example, an amount representing the user's insurance premium for an employer provided health coverage plan is added to the projected medical expenses during the time before retirement. A different amount representing the user's insurance premiums for a non-employer-provided health coverage plan is added to the medical expenses during the years the employee is retired, but is not eligible for Medicare. Finally, a third amount representing Medicare premiums is added to the medical expenses during the years the user is eligible for Medicare. The health-care coverage cost parameters are predetermined values. However, these values can be modified by the user. For example, an annual premium section 740 is supplied on health coverage parameter input screen 700. The annual medical expenses plus the annual health-care coverage costs represent the user's annual combined health-care costs.

HSA optimizer 100 applies inflation factors or cost growth models to each element of the annual combined health-care costs (step 150 of FIG. 1). In order to properly inflate the medical expense element of the combined health-care costs, HSA optimizer 100 takes into account various components included in the user's medical expenses. For example, prescription cost growth models, inpatient cost growth models, and outpatient cost growth models can be considered independently or combined in order to derive an aggregate medical expense growth model. A reasonable estimate of medical expense growth is projected based on recent period growth rate statistics for national health expenditures as a percentage of the gross domestic product (GDP) with an implied long-term flat rollover. In other words, the economic growth in medical expenses as a percent of GDP is forecast forward with the rollover to a reasonable maximum, e.g., 20% GDP. A rollover maximum is applied because it is unreasonable to project that medical expenses would continue to grow until they consumed the entire GDP.

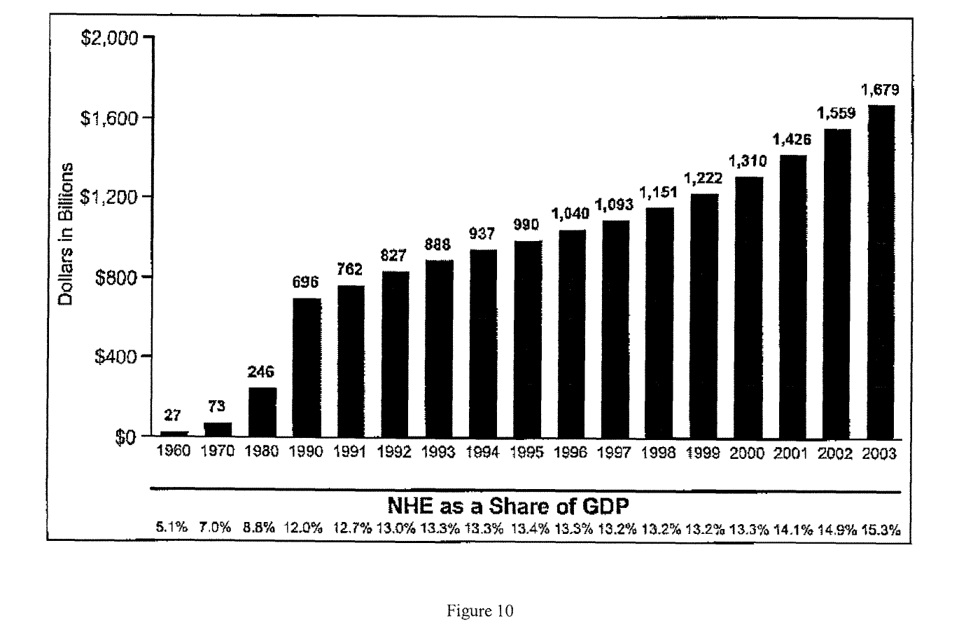

Data for national health expenditures as a percentage of GDP is available from the US Department of Health and Human Services' Centers for Medicare and Medicaid Services. For example, FIG. 10 is an illustration of national health expenditures (NHE) as a share of GDP from 1960 through 2003. A simple projection of GDP growth through the user's lifetime can be used in combination with this data to determine the rate of inflation of medical expenses. Likewise, HSA optimizer 100 adjusts for anticipated health-care coverage cost and coverage benefit changes over the user's life. For example, HSA optimizer 100 adjusts the parameters associated with premium amounts, deductible amounts, out-of-pocket plan maximums, coinsurance payments, and co-payments for medical services and medications. HSA optimizer 100 inflates the health-care coverage costs and modifies the benefits for the three periods described above (the pre-retirement period, the post-retirement/pre-Medicare period, and the Medicare period) according to recognized trends.

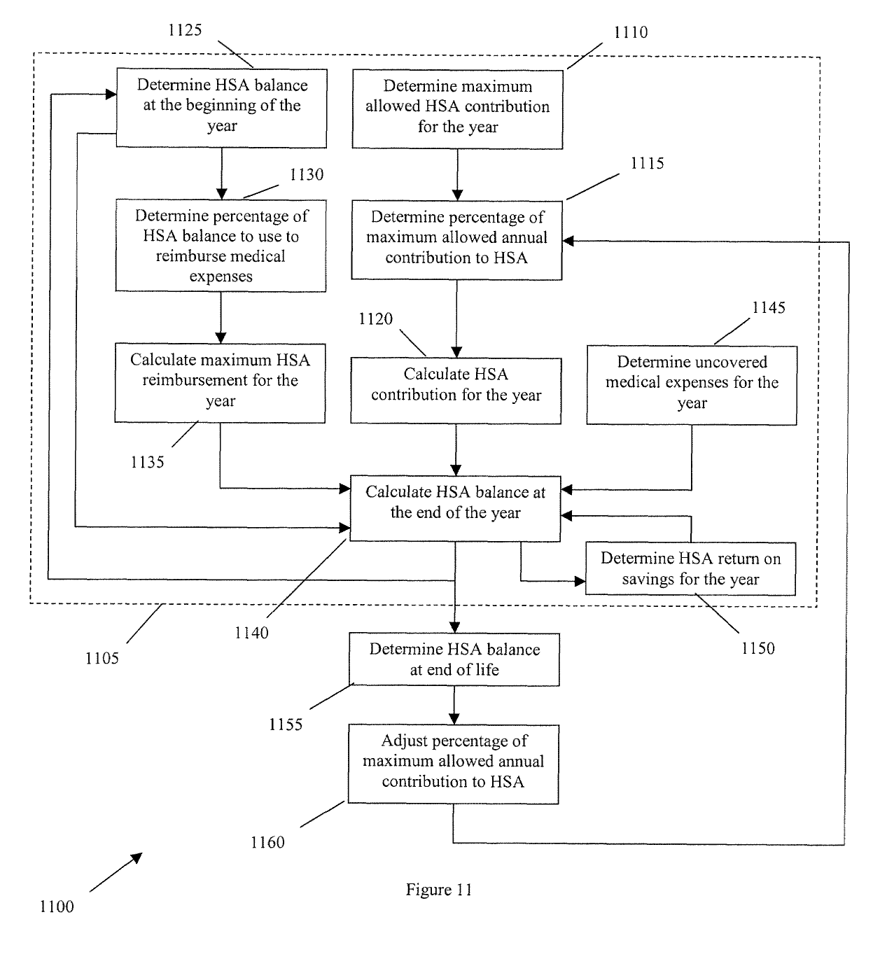

Referring to FIG. 11, HSA optimizer 100 implements an HSA balance estimation algorithm 1100 that estimates the user's HSA balance for each remaining year of the user's life based on the inflated annual combined health-care costs and HSA contribution, reimbursement, and growth parameters (step 160 of FIG. 1). According to HSA balance estimation algorithm 1100, a set of calculations 1105 is performed for each year of the user's remaining life to calculate the amount of HSA funds used to reimburse the user for uncovered medical expenses and to determine the projected HSA balance remaining at the end of each year. As described in greater detail below, HSA optimizer 100 iteratively executes HSA balance estimation algorithm 1100 while varying the user's annual HSA contribution amount to converge on an ideal HSA contribution amount. For example, an ideal HSA contribution amount is one that would provide sufficient HSA funds to pay the user's uncovered medical expenses throughout his or her life without leaving a balance remaining at the end of his or her life.

HSA balance estimation algorithm 1100 determines the maximum allowed HSA contribution for a particular year (step 1110) taking into account any rules, regulations, or laws governing HSA contribution amounts. For example, in the year 2006, a user may contribute as much as the amount of the deductible of his or her HDHP, up to a maximum of $2,700. The amount of the deductible of the user's HDHP is a user configurable parameter (described above in connection with FIG. 7); in alternative implementations, the deductible can be provided by the user's profile. HSA balance estimation algorithm 1100 can take into account the fact that the annual maximum HSA contribution limits may increase in future years by examining HSA contribution limit trend information.

HSA balance estimation algorithm 1100 determines a percentage of the maximum annual HSA contribution limit that the user wishes to make each year (step 1115). For the first iteration of HSA balance estimation algorithm 1100, the algorithm starts with an initial value of 100% and varies the percentage as described below. In alternative implementations, HSA balance estimation algorithm 1100 receives an initial percentage from the user or from another source, such as another computer application. Balance estimation algorithm 1100 multiplies the maximum allowed HSA contribution for the particular year and the percentage of the maximum allowed HSA contribution that the user wishes to contribute to his or her HSA to calculate the amount of funds that will be contributed to the HSA for the current calculation year (step 1120).

HSA balance estimation algorithm 1100 determines the HSA balance at the beginning of the current calculation year (step 1125). The initial balance for the first calculation year is zero if the user does not have an existing HSA. In some cases, the user may supply the current balance in his or her HSA or the initial HSA balance can be supplied by a calling application. Because HSA balance estimation algorithm 1100 is performed for each year of the user's remaining life, adjustments to the HSA balance will be made for each simulated year. HSA balance estimation algorithm 1100 determines the percentage of the current HSA balance to use to reimburse the user's medical expenses for the current calculation year (step 1130). The percentage to use for reimbursement is provided by the user. HSA balance estimation algorithm 1100 calculates the maximum HSA reimbursement for the year by multiplying the current HSA balance for the year and the percentage of the HSA balance to use to reimburse medical expenses (step 1135).

HSA balance estimation algorithm 1100 determines the HSA balance remaining at the end of the current calculation year by adding the amount of HSA funds that the user will contribute during the current calculation year to the HSA beginning balance and subtracting the amount of HSA funds that will be used to reimburse the user for the current calculation year from the HSA beginning balance (step 1140). The amount that will be used to reimburse the user for the current calculation year is the lesser of (1) the maximum possible HSA reimbursement for the year (determined in step 1135) or (2) the amount of uncovered annual medical expenses for the current calculation year, which can be determined as described above (step 1145). Once these deposits and withdrawals have been calculated, HSA balance estimation algorithm 1100 increases the HSA balance to reflect interest gained on the HSA balance during the current calculation year (step 1150). The user provides the interest rate used for this calculation, but HSA optimizer 100 can also provide an assumed interest rate in alternative implementations.

By running calculations 1105 for each year of the user's life, HSA optimizer 100 determines a running HSA balance for each year of the user's life. In addition, HSA balance estimation algorithm 1100 uses the running HSA balance to determine the HSA balance projected to remain after the last year of the user's life (step 1155). If a surplus HSA balance remains, HSA balance estimation algorithm 1100 reduces the percentage of the maximum annual HSA contribution limit that the user wishes to contribute to his or her HSA on an annual basis (used in step 1115) and reruns calculations 1105 for each year the user's life using this new percentage (step 1160). Conversely, if a deficit HSA balance occurs, HSA balance estimation algorithm 1100 increases this percentage (step 1160) and reruns calculations 1105. If this percentage value reaches 100% without resolving the deficit, HSA optimizer 100 informs the user that insufficient funds will be available in the user's HSA to reimburse the user for future uncovered medical expenses. Assuming this percentage does not reach 100%, HSA balance estimation algorithm 1100 increases or decreases this percentage amount, in a binary search fashion, until a percentage is found that will yield a remaining HSA balance of about zero in the last year of the user's life. HSA optimizer 100 presents this percentage to the user as the optimum maximum annual HSA contribution limit percentage to contribute, and HSA optimizer 100 converts the percentage to an absolute dollar amount for the first year of the user's remaining life using the maximum allowed HSA contribution limit determined for the first year of the user's remaining life.

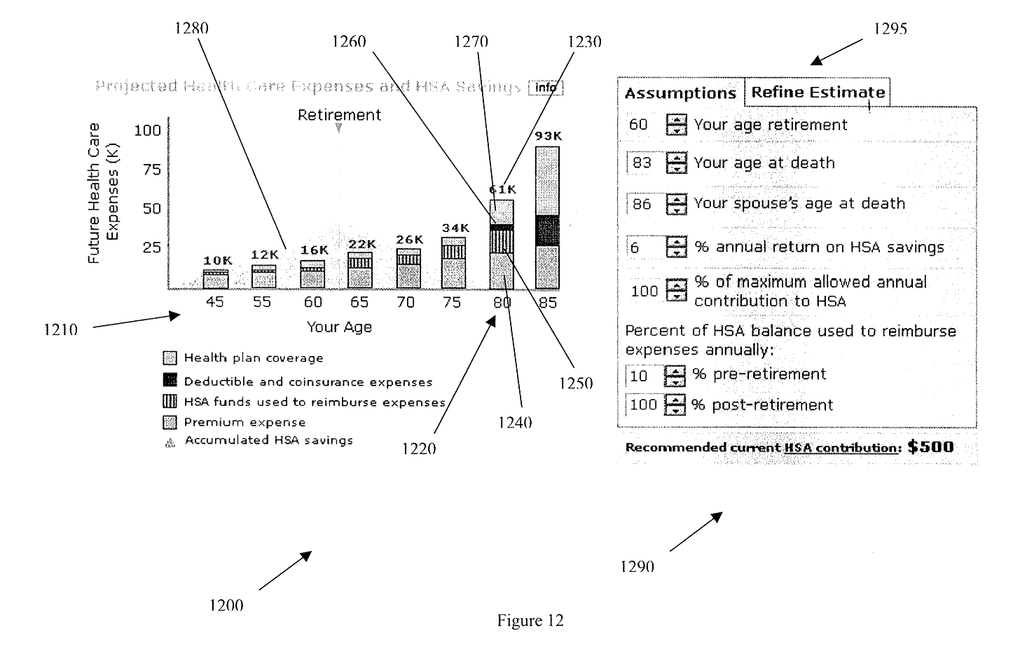

FIG. 12 is an example of a presentation screen 1200 for showing the user the results of the health-care costs projections, HSA balance projections, and recommended HSA contribution amount calculations. Presentation screen 1200 shows combined health-care costs of selected years 1210. A selected year 1220 shows a total combined health-care cost 1230 for the year 1220. Year 1220 also shows the combined health-care costs allocated into categories of premium expenses 1240, HSA funds used to reimburse medical expenses 1250, deductible and coinsurance expenses 1260, and medical expenses covered by health plan coverage 1270. Presentation screen 1200 also shows a running HSA balance 1280 for the remaining years of the user's life.

Presentation screen 1200 has an assumptions section 1290 that allows the user to adjust some of the parameters described above, e.g., retirement age, percentage of the maximum annual HSA contribution limit the user will contribute to his or her HSA, and percentage of HSA balance to use for reimbursing projected expenses. The user can vary these parameters and observe the effect on the projected health-care expenses and HSA savings. Likewise, a refine estimate sub-screen 1295 provides a link to other user-configurable parameters, such as those described above in connection with alternative implementations of HSA optimizer 100.

HSA optimizer 100 can optionally increase the annual medical expenses determined using the techniques described above to reflect a likelihood that the user may contract certain disease conditions during his or her remaining lifetime. These likelihoods are determined by evaluating a number of health risk factors given additional information about the user. This additional information is provided by user-configurable parameters. In alternative implementations, this information can be supplied by the user's profile. According to one illustrative technique of using risk factors to increase annual medical expenses, specific risk factors are correlated with specific conditions using known risk factor/condition relationships. For example, if the user currently has high blood pressure, the user's annual medical expenses can be increased by a predetermined percentage for each year to reflect the user's increased likelihood of experiencing a stroke during his or her remaining years of life. The yearly percentage increases are determined by comparing known historical health-care cost data for sample users that have experienced a stroke with health-care costs for sample users that have not experienced a stroke.

According to an alternative technique, HSA optimizer 100 uses techniques known in the art to increase the annual medical expenses prediction. One illustrative method determines the total number of risk factors that the user possesses and classifies the user as having a low, medium, or high risk level for increased medical expenses based on the total number of risk factors. This technique increases the annual medical expenses by a predetermined percentage for each year based on the risk level classification. The yearly percentage increases are determined by comparing known historical health-care cost data for sample users that have differing risk levels.

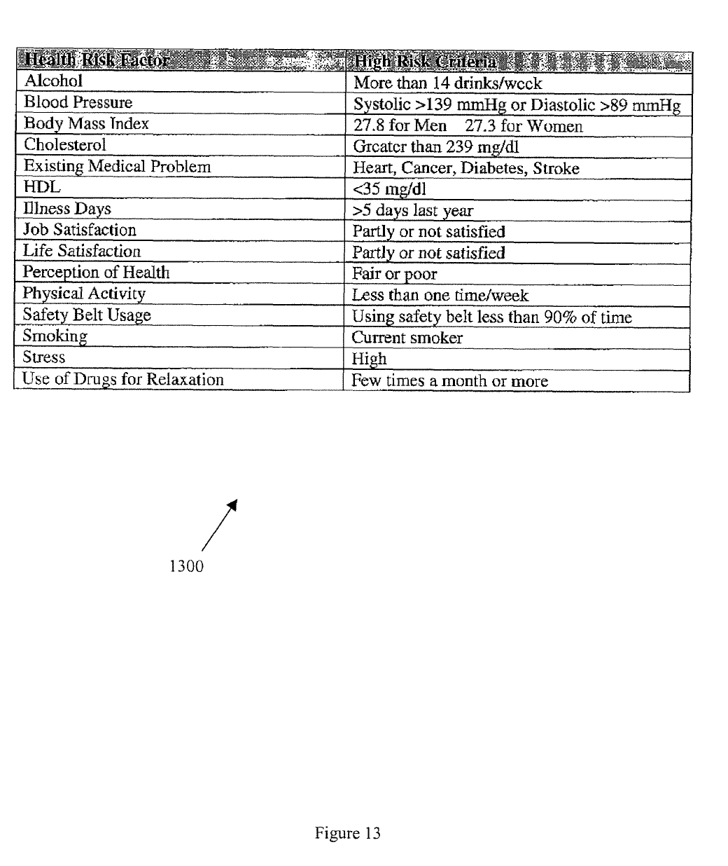

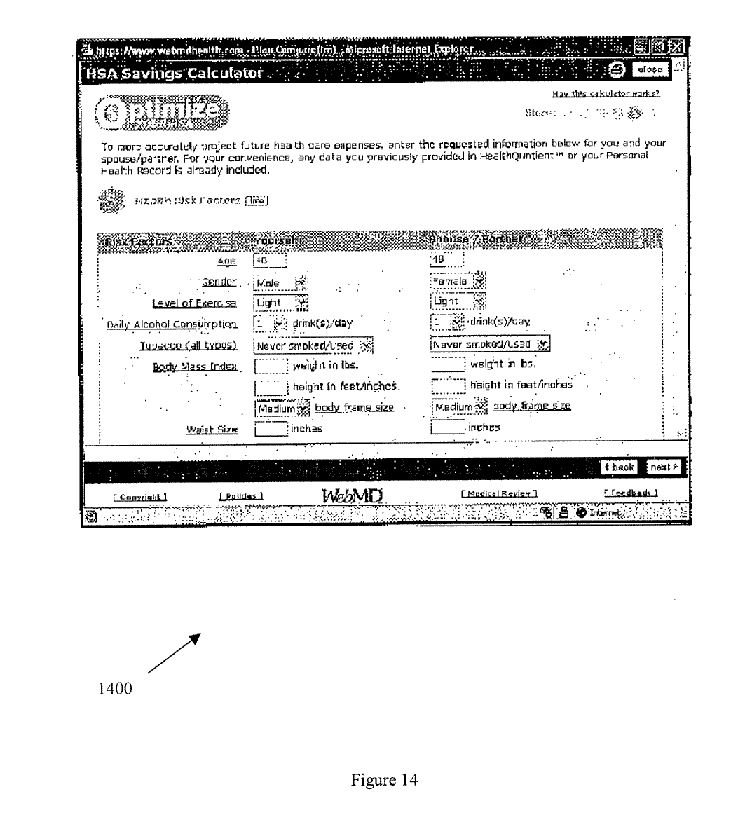

An illustrative list of health risk factors 1300 is provided in FIG. 13. Information pertaining to health risk factors 1300 can be supplied by a calling application, the user's profile, or by user input. FIG. 14 is an example of a health risk factor input screen 1400 that solicits user input used to evaluate the user's health risk level. Health risk factor input screen 1400 includes only a subset of the list of health risk factors 1300, but input screen 1400 can contain more, less, or different health risk factors in alternative implementations.

As described above, the user's profile can be used to provide specific items of information that would otherwise be solicited from the user. However, the information in the user's profile may also be used to predict health-related outcomes or situations that are not expressly stated in the user's profile or known to the user. For example, the user's profile may contain a history of past illnesses, doctor's office visits, health-related expenses, and current and past prescriptions. By analyzing this information, HSA optimizer 100 can predict that the user's total medical expenses may be higher than similarly situated sample individuals. Thus, this conclusion can be used to apply an escalation factor to the medical expense calculations described above.

The information in the user's profile may be supplied by various sources, as described above. Likewise, HSA optimizer 100 can provide information to the user's profile for use by other health maintenance tools and life planning tools. Thus, HSA optimizer 100 can be included in a suite of tools, and it can exchange information with the other tools, via the user's profile, to increase the accuracy and personalization of the information provided by the combined suite of tools. For example, the re estimated medical expenses and estimated HSA balance can be used to recommend the best health insurance plan for the user. Similarly, this data could be used by a retirement savings planning tool to predict the effect that out-of-pocket medical expenses will have on the user's retirement savings.

As will be realized, the invention is capable of other and different embodiments and its several details may be capable of modifications in various respects, all without departing from the invention as set out in the appended claims. For example, the methods and calculations described above may be performed for only a segment of the user's remaining years of life. Accordingly, the drawings and description are to be regarded as illustrative in nature and not in a restrictive or limiting sense with the scope of the application being indicated in the claims.

What is claimed is:

1. A computer implemented method for estimating for a user performance information for a health savings account, the method comprising:
estimating a chronological series of health-care expenses to be incurred by the user based on actuarial data for health-care costs;
estimating a chronological series of health savings account balance values based on the series of health-care expenses; and
presenting to the user information derived from at least one of the estimated series of health-care expenses or estimated series of health savings account balance values.

2. The method of claim 1, further comprising:
receiving at least one characteristic of the user;
wherein estimating the chronological series of health-care expenses comprises limiting the actuarial data used to estimate the chronological series of health-care expenses to data associated with individuals that share a similar classification as the user based on the characteristic of the user.

3. The method of claim 2, wherein the characteristics of the user include an age of the user, a gender of the user, and a geographic location of the user.

4. The method of claim 1, further comprising:
allocating the health-care expenses between amounts payable by a health coverage plan and amounts payable by the user based on a set of health coverage parameters;
wherein estimating the series of health savings account balance values is further based on the amounts payable by the health coverage plan.

5. The method of claim 1, further comprising:
estimating a remaining lifespan of the user;
calculating a recommended amount of funds to contribute to the health savings account so as to minimize the estimated absolute value of the health savings account balance value occurring at the end of the remaining lifespan of the user; and
presenting to the user information derived from the recommended amount of funds;
wherein estimating the series of health savings account balance values is further based on the recommended amount of funds to contribute to the health savings account.

6. A system for estimating for a user performance information for a health savings account, the system comprising:
a computer system;
an output device; and
program code on a computer-readable medium, which when executed on the computer system performs functions including:
estimating a chronological series of health-care expenses to be incurred by the user based on actuarial data for health-care costs;
estimating a chronological series of health savings account balance values based on the series of health-care expenses; and
presenting to the user through the output device information derived from at least one of the estimated series of health-care expenses or estimated series of health savings account balance values.

7. The system of claim 6, wherein the program code when executed on the computer system further performs the functions of:
receiving at least one characteristic of the user; and
wherein estimating the chronological series of health-care expenses comprises limiting the actuarial data used to estimate the chronological series of health-care expenses to data associated with individuals that share a similar classification as the user based on the characteristic of the user.

8. The system of claim 7, wherein the characteristics of the user include an age of the user, a gender of the user, and a geographic location of the user.

9. The system of claim 6, wherein the program code when executed on the computer system further performs the functions of:
allocating the health-care expenses between amounts payable by a health coverage plan and amounts payable by the user based on a set of health coverage parameters;
wherein estimating the series of health savings account balance values is further based on the amounts payable by the health coverage plan.

10. The system of claim 6, wherein the program code when executed on the computer system further performs the functions of:
estimating a remaining lifespan of the user;
calculating a recommended amount of funds to contribute to the health savings account so as to minimize the estimated absolute value of the health savings account balance value occurring at the end of the remaining lifespan of the user; and
presenting to the user through the output device information derived from the recommended amount of funds;
wherein estimating the series of health savings account balance values is further based on the recommended amount of funds to contribute to the health savings account.

11. A computer implemented method of estimating for a user future health-care expenses to be incurred by the user during discrete time periods over a predetermined timeframe, the method comprising:
receiving at least one characteristic of the user for each discrete time period;
accessing actuarial data for health-care costs, the data including cost information associated with health-care costs incurred by individuals and the data also including identifying information that characterize the individuals who incurred the health-care costs;
estimating a series of future health-care expenses to be incurred by the user during the discrete time periods over the predetermined timeframe based on the cost information contained in the data associated with only those individuals that share a classification similar to the user, the classification of the user for each discrete time period being based on the characteristic for each discrete time period, and the classification of the individuals being based on the identifying information that characterizes the individuals; and
presenting to the user information derived from the estimated series of future health-care expenses.

12. The method of claim 11, the identifying information including at least ages of the individuals when the individuals incurred the health-care costs and at least one of the characteristics of the user received being an age of the user during each discrete time period.

13. The method of claim 11, the identifying information including known health conditions of the individuals when the individuals incurred the health-care costs and at least one of the characteristics of the user received being a known health condition of the user during each discrete time period.

14. The method of claim 1 the identifying information including at least ages, genders, and geographic locations of the individuals when the individuals incurred the health-care costs and the characteristics of the user received being at least an age, gender, and geographic location of the user during each discrete time period.

15. The method of claim 1 further comprising:
receiving health risk factors possessed by the user;
estimating additional health-care expenses to be incurred by the user based on the health risk factors; and
presenting to the user information derived from the additional health-care expenses.

16. The method of claim 11, the predetermined timeframe being an estimated remaining lifespan of the user.

17. A system for estimating for a user future health-care expenses to be incurred by the user during discrete time periods over a predetermined timeframe, the system comprising:
a computer system;
an output device; and
program code on a computer-readable medium, which when executed on the computer system performs functions including:
receiving at least one characteristic of the user for each discrete time period;
accessing actuarial data for health-care costs, the data including cost information associated with health-care costs incurred by individuals and the data also including identifying information that characterize the individuals who incurred the health-care costs;
estimating a series of future health-care expenses to be incurred by the user during the discrete time periods over the predetermined timeframe based on the cost information contained in the data associated with only those individuals that share a classification similar to the user, the classification of the user for each discrete time period being based on the characteristic for each discrete time period, and the classification of the individuals being based on the identifying information that characterizes the individuals; and
presenting to the user through the output device information derived from the estimated series of future health-care expenses.

18. The system of claim 17, the identifying information including at least ages of the individuals when the individuals incurred the health-care costs and at least one of the characteristics of the user received being an age of the user during each discrete time period.

19. The system of claim 17, the identifying information including known health conditions of the individuals when the individuals incurred the health-care costs and at least one of the characteristics of the user received being a known health condition of the user during each discrete time period.

20. The system of claim 17, the identifying information including at least ages, genders, and geographic locations of the individuals when the individuals incurred the health-care costs and the characteristics of the user received being at least an age, gender, and geographic location of the user during each discrete time period.

21. The system of claim 17, the program code when executed on the computer system further performs the functions of:
receiving health risk factors possessed by the user;
estimating additional health-care expenses to be incurred by the user based on the identified health risk factors; and
presenting to the user information derived from the additional health-care expenses.

22. The system of claim 17, the predetermined timeframe being an estimated remaining lifespan of the user.
